(19) United States
(12) Patent Application Publication
(10) Pub. No.: US 2025/0313733 A1
(43) Pub. Date: Oct. 9, 2025

(54) BINDER, ADHESIVE TAPE, ELECTROCHEMICAL APPARATUS, AND ELECTRIC APPARATUS

(71) Applicant: DONGGUAN AMPEREX TECHNOLOGY LIMITED, Dongguan (CN)

(72) Inventors: Kewen HU, Dongguan (CN); Wei ZHUANG, Dongguan (CN)

(73) Assignee: DONGGUAN AMPEREX TECHNOLOGY LIMITED, Dongguan (CN)

(21) Appl. No.: 19/244,550

(22) Filed: Jun. 20, 2025

Related U.S. Application Data
(63) Continuation of application No. PCT/CN2022/140901, filed on Dec. 22, 2022.

(51) Int. Cl. C09J 133/08; C09J 11/04; C09J 11/06; C09J 11/08; H01M 10/0525; H01M 50/586; H01M 50/595

(52) U.S. Cl. CPC C09J 133/08; C09J 11/04; C09J 11/06; C09J 11/08; H01M 10/0525; H01M 50/586; H01M 50/595

(57) ABSTRACT

An the binder includes a styrene-isoprene-styrene block copolymer, an acrylic resin, and polyethylene glycol. Based on a mass of the binder, a sum of mass percentages of the styrene-isoprene-styrene block copolymer and the acrylic resin ranges from 65% to 85%, and a mass percentage of the polyethylene glycol ranges from 5% to 15%. The binder includes the styrene-isoprene-styrene block copolymer, the acrylic resin, and the polyethylene glycol, and the mass percentages of the styrene-isoprene-styrene block copolymer, the acrylic resin, and the polyethylene glycol are controlled within the above ranges, so that electrolyte resistance and adhesive properties of the binder can be improved.

### CROSS REFERENCE TO THE RELATED APPLICATIONS

This application is a continuation application of International Application No. PCT/CN2022/140901, filed on Dec. 22, 2022, the contents of which are incorporated herein by reference in its entirety.

### TECHNICAL FIELD

This application relates to the field of electrochemical technology, and more particularly, to a binder, an adhesive tape, an electrochemical apparatus, and an electric apparatus.

### BACKGROUND

During the manufacturing process of lithium-ion batteries, adhesive tape is required for insulation protection and fixation at locations such as a tail end of an electrode assembly, the outermost layer of the electrode assembly, and a tab extension region of the electrode plate. Currently, an adhesive tape specifically designed for lithium-ion batteries generally uses polyethylene terephthalate (PET) as the substrate and acrylate as the adhesive layer.

However, after the adhesive tape is soaked in an electrolyte, the adhesive strength of the adhesive tape is weakened, and during the degassing process, the adhesive tape may enter the side seal of the electrode assembly. This not only results in a loss of manufacturing yield of lithium-ion batteries but also causes poor encapsulation, leading to safety issues such as electrolyte leakage. In an electrolyte environment, the adhesive tape itself may swell and protrude, causing appearance defects in the lithium-ion battery, and this phenomenon becomes more pronounced as voltage increases. Therefore, how to improve the electrolyte resistance and adhesive properties of adhesive tape has become an urgent technical problem to be resolved by persons skilled in the art.

### SUMMARY

The purpose of this application is to provide a binder, an adhesive tape, an electrochemical apparatus, and an electric apparatus to improve the electrolyte resistance and adhesive properties of the adhesive tape. Applying the adhesive tape to an electrochemical apparatus can improve the performance of the electrochemical apparatus, such as safety performance and service life.

It should be noted that an example in which a lithium-ion battery is used as an electrochemical apparatus is used to illustrate this application below. However, the electrochemical apparatus in this application is not limited to the lithium-ion battery. Specific technical solutions are as follows.

According to a first aspect of this application, a binder is provided, including a styrene-isoprene-styrene block copolymer, an acrylic resin, and polyethylene glycol. Based on a mass of the binder, a sum of mass percentages of the styrene-isoprene-styrene block copolymer and the acrylic resin ranges from 65% to 85%, and a mass percentage of the polyethylene glycol ranges from 5% to 15%. The binder includes the styrene-isoprene-styrene block copolymer, the acrylic resin, and the polyethylene glycol, and controlling the mass percentages of the styrene-isoprene-styrene block copolymer, the acrylic resin, and the polyethylene glycol within the above ranges enables the binder to exhibit good electrolyte resistance, insulation properties, and chemical stability. Moreover, the binder demonstrates good adhesion to both non-polar and polar materials. Applying the binder to an adhesive layer of an adhesive tape improves the electrolyte resistance and adhesive properties of the adhesive tape. The adhesive tape uses the binder of this application to an electrochemical apparatus, and the adhesive tape is attached to different parts of an electrode assembly to provide effective insulation and fixation, thereby improving the performance of the electrochemical apparatus, such as safety performance and service life.

In some embodiments of this application, the binder further includes a tackifying resin, an antioxidant, and an additive. The tackifying resin includes at least one of rosin resin, terpene resin, C5 petroleum resin, C9 petroleum resin, and coumarone resin. The antioxidant includes at least one of pentaerythritol tetrakis(3,5-di-tert-butyl-4-hydroxy)phenylpropionate, n-octadecyl 3-(3,5-di-tert-butyl-4-hydroxyphenyl)propionate, tris(2,4-di-tert-butylphenyl) phosphite, bis(2,4-di-tert-butylphenyl)pentaerythritol diphosphite, distearyl thiodipropionate, bis(3,5-di-tert-butyl-4-hydroxyphenylpropionyl)hydrazine, 1,3,5-tris(3,5-di-tert-butyl-4-hydroxybenzyl)-1,3,5-triazine-2,4,6(1H,3H,5H)-trione, pentaerythritol tetrakis(3-laurylthiopropionate), and 4,6-bis(dodecylthiomethyl)-o-cresol. The additive includes at least one of carbon black, alumina, and titanium dioxide. Based on the mass of the binder, a mass percentage of the tackifying resin ranges from 5% to 15%, a mass percentage of the antioxidant ranges from 2% to 5%, and a mass percentage of the additive ranges from 2% to 5%. Further including the aforementioned types of tackifying resin, antioxidant, and additive in the binder, and controlling the mass percentages of the tackifying resin, the antioxidant, and the additive within the above ranges further facilitates the improvement of the electrolyte resistance, insulation properties, chemical stability, and adhesive properties of the binder. Applying the binder to the adhesive layer of the adhesive tape further improves the electrolyte resistance and adhesive properties of the adhesive tape.

In some embodiments of this application, a mass ratio of the acrylic resin to the styrene-isoprene-styrene block copolymer ranges from 1:1 to 2:1. Controlling the mass ratio of the acrylic resin to the styrene-isoprene-styrene block copolymer within the above range further facilitates the improvement of the electrolyte resistance, insulation properties, chemical stability, thermal stability, and adhesive properties of the binder. Preferably, the mass ratio of the acrylic resin to the styrene-isoprene-styrene block copolymer ranges from 1.2:1 to 1.8:1; and more preferably, the mass ratio of the acrylic resin to the styrene-isoprene-styrene block copolymer ranges from 1.4:1 to 1.6:1.

In some embodiments of this application, a weight-average molecular weight of the polyethylene glycol ranges from 300 to 8500, a weight-average molecular weight of the styrene-isoprene-styrene block copolymer ranges from 80000 to 120000, and a weight-average molecular weight of the acrylic resin ranges from 100000 to 200000. Controlling the weight-average molecular weights of the polyethylene glycol, the styrene-isoprene-styrene block copolymer, and the acrylic resin within the above ranges further improves the adhesive properties of the binder while maintaining good electrolyte resistance, insulation properties, and chemical stability. In some embodiments of this application, the acrylic resin includes at least one of butyl methacrylate, dimethylaminoethyl methacrylate, and methyl methacrylate. Applying the aforementioned types of acrylic resin to the binder further facilitates the improvement of the adhesion of the binder to non-polar and polar materials.

According to a second aspect of this application, an adhesive tape is provided, including a substrate layer and an adhesive layer disposed on at least one surface of the substrate layer. The adhesive layer includes the binder described in any of the foregoing embodiments, and the substrate layer includes at least one of polyethylene terephthalate, polyimide, and polypropylene. Applying the binder to the adhesive layer of the adhesive tape improves the electrolyte resistance and adhesive properties of the adhesive tape. The adhesive tape is applied to an electrochemical apparatus, and the adhesive tape is attached to different parts of an electrode assembly to provide effective insulation and fixation, thereby improving the performance of the electrochemical apparatus, such as safety performance and service life.

In some embodiments of this application, a thickness of the adhesive tape ranges from 8 m to 40 m, a thickness of the adhesive layer ranges from 3 m to 10 m, and a thickness of the substrate layer ranges from 5 m to 30 m. Controlling the thicknesses of the adhesive tape, the adhesive layer, and the substrate layer within the above ranges enables the adhesive tape to exhibit good electrolyte resistance and adhesive properties while ensuring the puncture resistance of the adhesive tape, and facilitates the reduction of a volume of the electrochemical apparatus, thereby increasing the energy density of the electrochemical apparatus.

In some embodiments of this application, an initial adhesion force of the adhesive tape ranges from 100 N/m to 500 N/m. After the adhesive tape is soaked in a lithium-salt-free electrolyte at 85° C. for 4 h and then hot-pressed at 85° C. under a pressure of 1 MPa, an adhesive strength of the adhesive tape ranges from 50 N/m to 400 N/m. The lithium-salt-free electrolyte is prepared by mixing ethylene carbonate, propylene carbonate, diethyl carbonate, and ethyl propionate at a mass ratio of 30:10:30:30. This indicates that the adhesive tape exhibits good electrolyte resistance and adhesive properties.

In some embodiments of this application, the puncture resistance of the adhesive tape ranges from 4 N to 10 N. This indicates that the adhesive tape has good puncture resistance, which can prolong a service life of the adhesive tape, thereby improving the performance of the electrochemical apparatus, such as safety performance and service life.

In some embodiments of this application, a thickness A of the adhesive tape after soaking in the lithium-salt-free electrolyte at 85° C. for 24 h and a thickness B of the adhesive tape before soaking in the lithium-salt-free electrolyte satisfy: 0 μm≤A−B≤2 μm. This indicates that the adhesive tape provided by this application has a low swelling degree, thereby facilitating the improvement of the performance of the electrochemical apparatus, such as safety performance and service life.

In some embodiments of this application, after the adhesive tape is hot-pressed at a temperature of 85° C. under a pressure of 1 MPa for 1 h, a maximum single-side adhesive overflow width of the adhesive tape ranges from 0 mm to 1 mm. This indicates that the adhesive tape of this application has good thermal stability, which facilitates the improvement of the performance of the electrochemical apparatus, such as safety performance and service life.

According to a third aspect of this application, an electrochemical apparatus is provided, including the adhesive tape described in any of the foregoing embodiments. Therefore, the electrochemical apparatus exhibits good performance, such as good safety performance and long service life.

According to a fourth aspect of this application, an electric apparatus is provided, including the electrochemical apparatus described in any of the foregoing embodiments. Therefore, the electric apparatus exhibits good performance, such as good safety performance and long service life.

### BRIEF DESCRIPTION OF DRAWINGS

To describe the technical solutions in some embodiments of this application and in the prior art more clearly, the following briefly describes the accompanying drawings required for describing some embodiments and the prior art. Apparently, the accompanying drawings in the following descriptions show only some embodiments of this application, and persons of ordinary skill in the art may still derive other drawings from these accompanying drawings.

FIG. 1 is a schematic diagram of a cross-sectional structure along a thickness direction of an adhesive tape in some embodiments of this application;

FIG. 2 is a schematic diagram of a cross-sectional structure along a thickness direction of an adhesive tape in some other embodiments of this application;

FIG. 3 is a schematic diagram of an attachment position of an adhesive tape on a negative electrode plate in some embodiments of this application;

FIG. 4 is a schematic diagram of an attachment position of an adhesive tape on a positive electrode plate in some embodiments of this application;

FIG. 5 is a schematic diagram of attachment positions of an adhesive tape on a positive electrode plate and a negative electrode plate in some other embodiments of this application;

FIG. 6 is a schematic diagram of an attachment position of an adhesive tape in an electrode assembly of a wound structure in some embodiments of this application;

FIG. 7 is a schematic diagram of an attachment position of an adhesive tape on surface A of the electrode assembly in FIG. 6;

FIG. 8 is a schematic diagram of an attachment position of an adhesive tape on surface B of the electrode assembly in FIG. 6; and

FIG. 9 is a schematic diagram of an attachment position of an adhesive tape in an electrode assembly of a wound structure in some other embodiments of this application.

### DESCRIPTION OF EMBODIMENTS

To make the objectives, technical solutions, and advantages of this application more comprehensible, the following describes this application in detail with reference to accompanying drawings and embodiments. Apparently, the described embodiments are merely some but not all of the embodiments of this application. All other embodiments obtained by persons of ordinary skill in the art based on some embodiments of this application shall fall within the protection scope of this application.

It should be noted that, in the specific embodiments of this application, an example in which a lithium-ion battery is used as an electrochemical apparatus is used to illustrate this application. However, the electrochemical apparatus of this application is not limited to the lithium-ion battery.

According to a first aspect of this application, a binder is provided, including a styrene-isoprene-styrene block copolymer, an acrylic resin, and polyethylene glycol. Based on a mass of the binder, a sum W₁ of mass percentages of the styrene-isoprene-styrene block copolymer (abbreviated as SIS) and the acrylic resin ranges from 65% to 85%, and a mass percentage W₂ of the polyethylene glycol ranges from 5% to 15%. For example, the sum W₁ of the mass percentages of the styrene-isoprene-styrene block copolymer and the acrylic resin is 65%, 67%, 69%, 71%, 73%, 75%, 77%, 79%, 81%, 83%, 85%, or any value within a range between any two of the foregoing values. The mass percentage W₂ of the polyethylene glycol is 5%, 7%, 9%, 11%, 13%, 15%, or any value within a range between any two of the foregoing values. The binder includes the styrene-isoprene-styrene block copolymer, the acrylic resin, and the polyethylene glycol, and controlling the mass percentages of the styrene-isoprene-styrene block copolymer, the acrylic resin, and the polyethylene glycol within the above ranges enables the binder to exhibit good electrolyte resistance, insulation properties, and chemical stability. Moreover, the binder demonstrates good adhesion to both non-polar and polar materials. Applying the binder to an adhesive layer of an adhesive tape improves the electrolyte resistance and adhesive properties of the adhesive tape. The adhesive tape using the binder of this application is applied to an electrochemical apparatus, and the adhesive tape is attached to different parts of an electrode assembly to provide effective insulation and fixation, thereby improving the performance of the electrochemical apparatus, such as safety performance and service life.

This application imposes no specific limitation on a mass ratio of styrene to isoprene in the styrene-isoprene-styrene block copolymer, as long as the objectives of this application can be achieved. Preferably, in some embodiments of this application, the mass ratio of styrene to isoprene ranges from (10 to 20):(80 to 90).

In some embodiments of this application, the binder further includes a tackifying resin, an antioxidant, and an additive. The tackifying resin includes at least one of rosin resin, terpene resin, C5 petroleum resin, C9 petroleum resin, and coumarone resin. The antioxidant includes at least one of pentaerythritol tetrakis(3,5-di-tert-butyl-4-hydroxy)phenylpropionate, n-octadecyl 3-(3,5-di-tert-butyl-4-hydroxyphenyl)propionate, tris(2,4-di-tert-butylphenyl) phosphite, bis(2,4-di-tert-butylphenyl)pentaerythritol diphosphite, distearyl thiodipropionate, bis(3,5-di-tert-butyl-4-hydroxyphenylpropionyl)hydrazine, 1,3,5-tris(3,5-di-tert-butyl-4-hydroxybenzyl)-1,3,5-triazine-2,4,6(1H,3H,5H)-trione, pentaerythritol tetrakis(3-laurylthiopropionate), and 4,6-bis(dodecylthiomethyl)-o-cresol. The additive includes at least one of carbon black, alumina, and titanium dioxide. Based on the mass of the binder, a mass percentage W₃ of the tackifying resin ranges from 5% to 15%, a mass percentage W₄ of the antioxidant ranges from 2% to 5%, and a mass percentage W₅ of the additive ranges from 2% to 5%. For example, the mass percentage W₃ of the tackifying resin is 5%, 7%, 9%, 11%, 13%, 15%, or any value within a range between any two of the foregoing values; the mass percentage W₄ of the antioxidant is 2%, 3%, 4%, 5%, or any value within a range between any two of the foregoing values; and the mass percentage W₅ of the additive is 2%, 3%, 4%, 5%, or any value within a range between any two of the foregoing values. Further including the aforementioned types of tackifying resin, antioxidant, and additive in the binder, and controlling the mass percentages of the tackifying resin, the antioxidant, and the additive within the above ranges, further facilitates the improvement of the electrolyte resistance, insulation properties, chemical stability, and adhesive properties of the binder. Applying the binder to the adhesive layer of the adhesive tape further improves the electrolyte resistance and adhesive properties of the adhesive tape. The adhesive tape using the binder of this application is applied to an electrochemical apparatus, and the adhesive tape is attached to different parts of an electrode assembly to provide effective insulation and fixation, thereby further improving the performance of the electrochemical apparatus, such as safety performance and service life.

In some embodiments of this application, a mass ratio of the acrylic resin to the styrene-isoprene-styrene block copolymer ranges from 1:1 to 2:1. For example, the mass ratio of the acrylic resin to the styrene-isoprene-styrene block copolymer is 1:1, 1.2:1, 1.4:1, 1.6:1, 1.8:1, 2:1, or any ratio within a range between any two of the foregoing ratios. Controlling the mass ratio of the acrylic resin to the styrene-isoprene-styrene block copolymer within the above range allows the acrylic resin and the styrene-isoprene-styrene block copolymer to form a stable bicontinuous structure with good compatibility. A carbonyl group and a benzene ring form a complex, and a Fourier transform infrared spectrum analyzer (FTIR) shows a strong absorption peak at 1720 cm¹. In addition, a glass transition temperature (Tg) of the acrylic resin increases, which further facilitates the improvement of the electrolyte resistance, insulation properties, chemical stability, thermal stability, and adhesive properties of the binder. Applying the binder to the adhesive layer of the adhesive tape further improves the electrolyte resistance and adhesive properties of the adhesive tape. The adhesive tape using the binder of this application is applied to an electrochemical apparatus, and the adhesive tape is attached to different parts of an electrode assembly to provide effective insulation and fixation, thereby further improving the performance of the electrochemical apparatus, such as safety performance and service life. In this application, the aforementioned “bicontinuous structure”, also known as a “sea-sea” structure, is a morphology of a polymer. It refers to a state where the polymer is partially compatible, and a mixing ratio reaches a stable value, achieving uniform layer-by-layer distribution or mutual entanglement through mechanical stirring. This structure can be verified by using a solvent etching method: at 25° C., the binder of this application is respectively immersed in n-heptane and acetone for 12 consecutive days, and the binder remains stable without flocculent dispersion. The “mechanical stirring” herein refers to mechanical stirring well known in the art. A preferred range of the mass ratio of the acrylic resin to the styrene-isoprene-styrene block copolymer is from 1.2:1 to 1.8:1, to obtain a more stable bicontinuous structure, resulting in better electrolyte resistance, insulation properties, chemical stability, thermal stability, and adhesive properties of the binder. The most preferred range of the mass ratio of the acrylic resin to the styrene-isoprene-styrene block copolymer is from 1.4:1 to 1.6:1, enabling the binder to exhibit optimal initial adhesion force, adhesive strength, low adhesive overflow, and minimal swelling, thereby improving the electrolyte resistance, insulation properties, and chemical stability.

In some embodiments of this application, a weight-average molecular weight Mw₂ of the polyethylene glycol ranges from 300 to 8500, a weight-average molecular weight Mw₁₋₁ of the styrene-isoprene-styrene block copolymer ranges from 80000 to 120000, and a weight-average molecular weight Mw₁₋₂ of the acrylic resin ranges from 100000 to 200000. For example, the weight-average molecular weight Mw₂ of the polyethylene glycol is 300, 1000, 2000, 3000, 4000, 5000, 6000, 7000, 8000, 8500, or any value within a range between any two of the foregoing values. The weight-average molecular weight Mw₁₋₁ of the styrene-isoprene-styrene block copolymer is 80000, 85000, 90000, 95000, 100000, 105000, 110000, 115000, 120000, or any value within a range between any two of the foregoing values. The weight-average molecular weight Mw₁₋₂ of the acrylic resin is 100000, 110000, 120000, 130000, 140000, 150000, 160000, 170000, 180000, 190000, 200000, or any value within a range between any two of the foregoing values. Controlling the weight-average molecular weights of the polyethylene glycol, the styrene-isoprene-styrene block copolymer, and the acrylic resin within the above ranges allows the polyethylene glycol to be dissolved into a framework formed by the styrene-isoprene-styrene block copolymer and the acrylic resin, providing a wetting effect and further enhancing the adhesive strength of the binder. This further facilitates the improvement of the adhesive properties of the binder while the binder has good electrolyte resistance, insulation properties, and chemical stability. Applying the binder to the adhesive layer of the adhesive tape further improves the electrolyte resistance and adhesive properties of the adhesive tape.

This application imposes no specific limitation on a method for controlling the weight-average molecular weight, and methods well known in the art can be used, as long as the objectives of this application can be achieved. For example, a degree of crosslinking of molecular chains can be adjusted by controlling reaction parameters such as reaction temperature, reaction time, and initiator amount during the preparation of polymers such as polyethylene glycol, SIS, and acrylic resin, to obtain polymers with different weight-average molecular weights.

In some embodiments of this application, the acrylic resin includes at least one of butyl methacrylate, dimethylaminoethyl methacrylate, and methyl methacrylate. The aforementioned types of acrylic resin have a non-polar main chain with polar side chains, exhibiting both hydrophobicity and hydrophilicity. Applying the aforementioned types of acrylic resin to the binder further facilitates the improvement of the adhesion of the binder to non-polar and polar materials. Applying a binder using the aforementioned types of acrylic resin to the adhesive layer of the adhesive tape further facilitates the improvement of the adhesive properties of the adhesive tape while maintaining good electrolyte resistance.

This application imposes no specific limitation on a preparation method of the binder, as long as the objectives of this application can be achieved. For example, the binder of this application can be prepared by heating, stirring, and uniformly mixing the styrene-isoprene-styrene block copolymer, the acrylic resin, the polyethylene glycol, the tackifying resin, the antioxidant, and the additive at a temperature of 150° C. to 180° C. Based on the mass of the binder, the sum of the mass percentages of the styrene-isoprene-styrene block copolymer and the acrylic resin ranges from 65% to 85%, the mass percentage of the polyethylene glycol ranges from 5% to 15%, the mass percentage of the tackifying resin ranges from 5% to 15%, the mass percentage of the antioxidant ranges from 2% to 5%, and the mass percentage of the additive ranges from 2% to 5%. This application imposes no specific limitation on a duration of the aforementioned “heating”, as long as the objectives of this application can be achieved. For example, the heating duration ranges from 20 min to 180 min. The aforementioned “stirring” refers to stirring well known in the art.

This application imposes no specific limitation on an application method of the binder, as long as the objectives of this application can be achieved. For example, in some embodiments of this application, the binder can be directly applied to an electrochemical apparatus, for example, being used as a dispensing adhesive directly applied to adhesion of a separator in a lithium-ion battery (a region, extending beyond a negative electrode plate, of each separator layer in a stacked electrode assembly), adhesion between an electrode assembly and a packaging case (a front side, a back side, or both sides of the electrode assembly in contact with the packaging case), and adhesion at the head, tail, and edges of the electrode assembly (head, tail, and side positions of the electrode assembly). In some embodiments of this application, the binder can be applied to an adhesive tape to form an adhesive layer, and used in the form of an adhesive tape in an electrochemical apparatus or other applicable products.

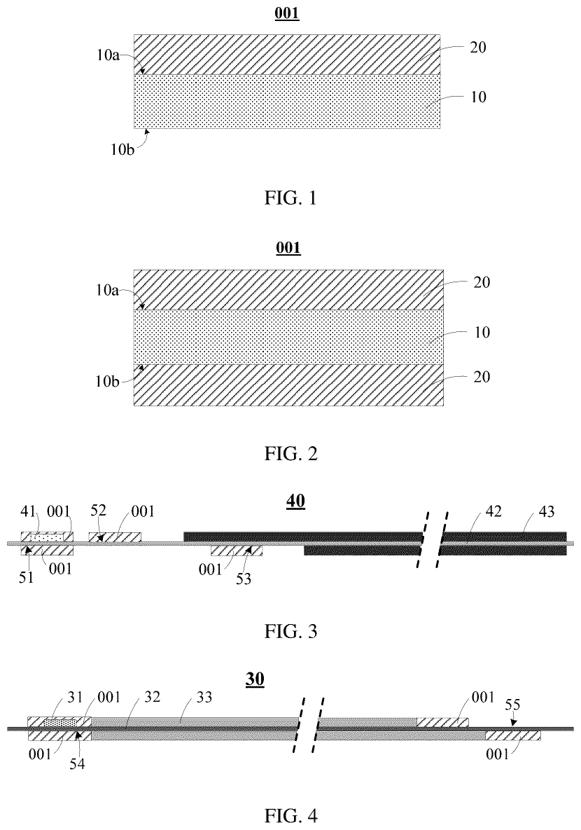

According to a second aspect of this application, an adhesive tape is provided, including a substrate layer and an adhesive layer disposed on at least one surface of the substrate layer. The adhesive layer includes the binder described in any of the foregoing embodiments, and the substrate layer includes at least one of polyethylene terephthalate, polyimide, and polypropylene. For example, as shown in FIG. 1, an adhesive tape 001 includes a substrate layer 10 and an adhesive layer 20. The substrate layer 10 includes two opposite surfaces 10a and 10b, and the adhesive layer 20 is disposed on one surface 10a of the substrate layer 10, forming a single-sided adhesive tape. Certainly, the adhesive layer 20 may alternatively be disposed on the other surface 10b of the substrate layer 10, forming a single-sided adhesive tape. Alternatively, as shown in FIG. 2, the adhesive layer 20 may be disposed on both surfaces 10a and 10b of the substrate layer 10, forming a double-sided adhesive tape. Applying the binder to the adhesive layer of the adhesive tape improves the electrolyte resistance and adhesive properties of the adhesive tape. The adhesive tape is applied to an electrochemical apparatus, and the adhesive tape is attached to different parts of an electrode assembly to provide effective insulation and fixation, thereby improving the performance of the electrochemical apparatus, such as safety performance and service life.

In some embodiments of this application, a thickness of the adhesive tape ranges from 8 m to 40 m, a thickness of the adhesive layer ranges from 3 m to 10 m, and a thickness of the substrate layer ranges from 5 m to 30 m. For example, the thickness of the adhesive tape is 8 m, 12 m, 16 m, 18 am, 22 am, 26 am, 28 am, 32 am, 36 am, 40 am, or any value within a range between any two of the foregoing values; the thickness of the adhesive layer is 3 am, 4 am, 5 am, 6 am, 7 am, 8 am, 9 am, 10 am, or any value within a range between any two of the foregoing values; and the thickness of the substrate layer is 5 am, 10 am, 15 am, 20 am, 25 am, 30 am, or any value within a range between any two of the foregoing values. Controlling the thicknesses of the adhesive tape, the adhesive layer, and the substrate layer within the above ranges enables the adhesive tape to exhibit good electrolyte resistance and adhesive properties while facilitating a reduction in a volume of the electrochemical apparatus, thereby increasing the energy density of the electrochemical apparatus. In this application, the thickness of the adhesive tape refers to a sum of the thickness of the adhesive layer and the thickness of the substrate layer.

In some embodiments of this application, the adhesive tape further includes an anti-adhesion layer, and the anti-adhesion layer is disposed on a surface of the adhesive layer facing away from the substrate layer. The provision of the anti-adhesion layer in the adhesive tape is intended to prevent the adhesive layer from contacting a non-adhesion target or itself, thereby facilitating storage and transportation of the adhesive tape. In this application, the anti-adhesion layer includes release paper or a release film. This application imposes no specific limitation on a type of the release paper or the release film, as long as the objectives of this application can be achieved.

In some embodiments of this application, an initial adhesion force of the adhesive tape ranges from 100 N/m to 500 N/m. After the adhesive tape is soaked in a lithium-salt-free electrolyte at 85° C. for 4 h and then hot-pressed at 85° C. under a pressure of 1 MPa, an adhesive strength of the adhesive tape ranges from 50 N/m to 400 N/m. The lithium-salt-free electrolyte is prepared by mixing ethylene carbonate, propylene carbonate, diethyl carbonate, and ethyl propionate at a mass ratio of 30:10:30:30. For example, the initial adhesion force of the adhesive tape is 100 N/m, 150 N/m, 200 N/m, 250 N/m, 300 N/m, 350 N/m, 400 N/m, 450 N/m, 500 N/m, or any value within a range between any two of the foregoing values. After the adhesive tape is soaked in the lithium-salt-free electrolyte at 85° C. for 4 h and then hot-pressed at 85° C. under a pressure of 1 MPa, the adhesive strength of the adhesive tape is 50 N/m, 150 N/m, 200 N/m, 250 N/m, 300 N/m, 350 N/m, 400 N/m, or any value within a range between any two of the foregoing values. The adhesive tape still has high adhesive strength after being soaked in the electrolyte for a certain period, indicating that the adhesive tape exhibits good electrolyte resistance and adhesive properties.

In some embodiments of this application, a puncture resistance of the adhesive tape ranges from 4 N to 10 N. For example, the puncture resistance of the adhesive tape is 4 N, 5 N, 6 N, 7 N, 8 N, 9 N, 10 N, or any value within a range between any two of the foregoing values. This indicates that the adhesive tape has good puncture resistance. When the adhesive tape is attached to components with burrs (such as nickel-plated copper tabs) in an electrode assembly, the adhesive tape can reduce the risk of short circuits in the electrochemical apparatus caused by burrs, thereby improving the performance of the electrochemical apparatus, such as safety performance and service life.

In some embodiments of this application, a thickness A of the adhesive tape after soaking in the lithium-salt-free electrolyte at 85° C. for 24 hours and a thickness B of the adhesive tape before soaking in the lithium-salt-free electrolyte satisfy: 0 μm≤A−B≤2 m. For example, a value of A−B may be 0 μm, 0.5 μm, 1 μm, 1.5 μm, 2 μm, or any value within a range between any two of the foregoing values. This indicates that the adhesive tape provided by this application has a low swelling degree, thereby facilitating the improvement of the performance of the electrochemical apparatus, such as safety performance and service life.

In some embodiments of this application, after the adhesive tape is hot-pressed at a temperature of 85° C. and a pressure of 1 MPa for 1 h, a maximum single-side adhesive overflow width of the adhesive tape ranges from 0 mm to 1 mm. For example, the maximum single-side adhesive overflow width of the adhesive tape may be 0 mm, 0.1 mm, 0.2 mm, 0.3 mm, 0.4 mm, 0.5 mm, 0.6 mm, 0.7 mm, 0.8 mm, 0.9 mm, 1 mm, or any value within a range between any two of the foregoing values. This indicates that the adhesive tape of this application has good thermal stability, which facilitates the improvement of the performance of the electrochemical apparatus, such as safety performance and service life.

This application imposes no specific limitation on a preparation method of the adhesive tape, as long as the objectives of this application can be achieved. For example, the adhesive tape can be prepared using the following method including the following steps: preparing a material of the substrate layer to obtain a substrate layer with a thickness of 5 μm to 30 μm; and coating at least one surface of the substrate layer with the binder of this application in a hot melting manner to form an adhesive layer with a thickness of 3 μm to 10 μm, thereby obtaining the adhesive tape of this application.

According to a third aspect of this application, an electrochemical apparatus is provided, including the adhesive tape described in any of the foregoing embodiments. Therefore, the electrochemical apparatus exhibits good performance, such as good safety performance and long service life.

In some embodiments of this application, the electrochemical apparatus further includes an electrode assembly and a packaging case, and the electrode assembly is accommodated in the packaging case. This application imposes no specific limitation on a structure of the electrode assembly, which can include a wound structure or a stacked structure. In this application, the electrode assembly includes a separator, a positive electrode plate, and a negative electrode plate. The separator is configured to separate the positive electrode plate and the negative electrode plate to prevent internal short circuits in the electrochemical apparatus, while allowing electrolyte ions to pass freely to complete an electrochemical charge-discharge process. This application imposes no specific limitation on the number and type of the separator, the positive electrode plate, and the negative electrode plate, as long as the objectives of this application can be achieved. The positive electrode plate includes a positive electrode tab, and the negative electrode plate includes a negative electrode tab. This application imposes no specific limitation on the packaging case, which may be a packaging case well known in the art, as long as the objectives of this application can be achieved.

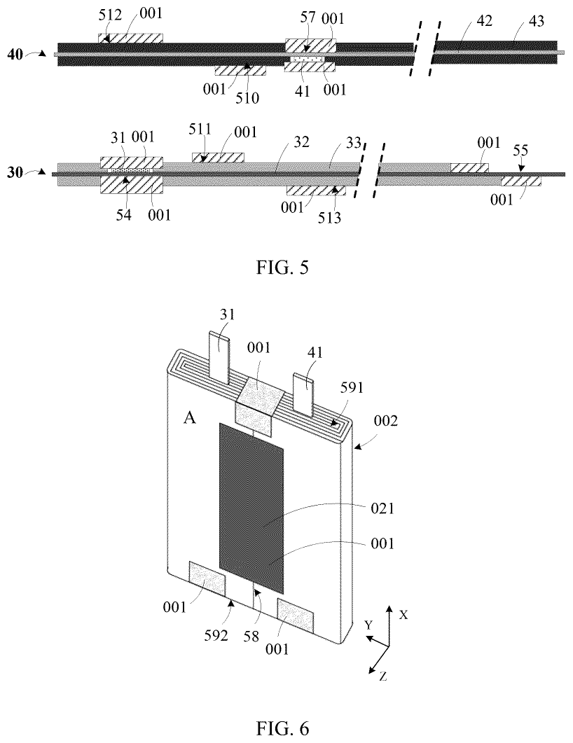

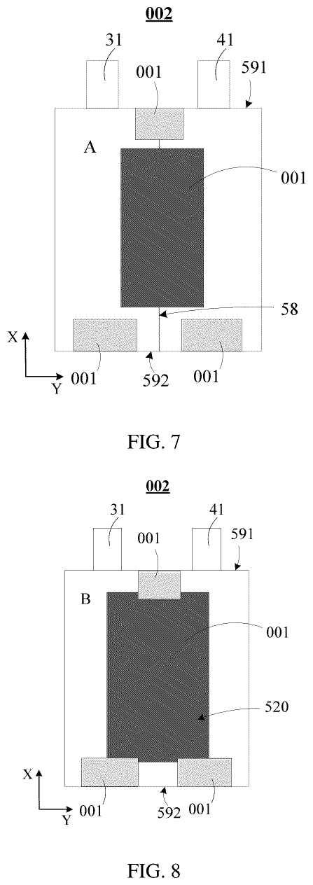

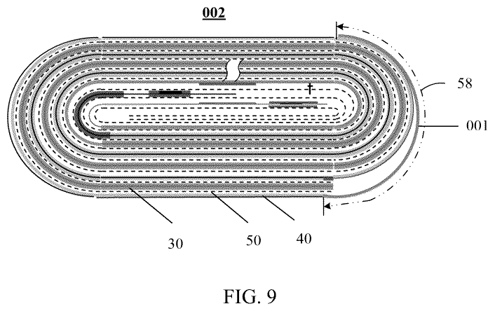

In some embodiments of this application, the structure of the electrode assembly is a wound structure, and the electrode assembly has at least one positive electrode tab and one negative electrode tab extending from the positive electrode plate and the negative electrode plate, respectively. This application imposes no specific limitation on an attachment position of the adhesive tape described in any of the foregoing embodiments in the electrode assembly of the wound structure, as long as the objectives of this application can be achieved. For example, in some embodiments of this application, a positive electrode plate 30 shown in FIG. 4 and a positive electrode plate 30 shown in FIG. 5 are two different types in different embodiments. The positive electrode plate 30 includes a positive electrode current collector 32 and a positive electrode active material layer 33 disposed on at least one surface of the positive electrode current collector 32. As shown in FIG. 4 and FIG. 5, an adhesive tape 001 can be attached to a positive electrode connection region 54 between a positive electrode tab 31 and the positive electrode plate 30, serving as a tab protection tape and an electrode plate protection tape. A negative electrode plate 40 shown in FIG. 3 and a negative electrode plate 40 shown in FIG. 5 are two different types in different embodiments. The negative electrode plate 40 includes a negative electrode current collector 42 and a negative electrode active material layer 43 disposed on at least one surface of the negative electrode current collector 42. As shown in FIG. 3, the adhesive tape 001 can be attached to a first negative electrode connection region 51 between a negative electrode tab 41 and the negative electrode plate 40, serving as a tab protection tape and an electrode plate protection tape. As shown in FIG. 5, the adhesive tape 001 can be attached to a second negative electrode connection region 57 between the negative electrode tab 41 and the negative electrode plate 40, serving as a tab protection tape. As shown in FIG. 3 to FIG. 5, the adhesive tape 001 can be attached to a positive electrode uncoated foil region 55 in the positive electrode plate 30 where the positive electrode active material layer 33 is not provided, and can be attached to negative electrode uncoated foil regions 52 and 53 in the negative electrode plate 40 where the negative electrode active material layer 43 is not provided, serving as an electrode plate protection tape. The tab protection tape can be used to fix the positive electrode tab 31 and the negative electrode tab 41, reducing a risk of burrs on surfaces of the positive electrode tab 31 and the negative electrode tab 41 piercing the packaging case or other components so as not to cause short circuits or other safety hazards in a lithium-ion battery, and reducing a risk of weld point tearing or tab breakage during a drop of the electrochemical apparatus. The use of the electrode plate protection tape can reduce a risk of short circuits or other safety hazards in the lithium-ion battery caused by burrs in the positive electrode plate and/or the negative electrode plate. In some embodiments of this application, FIG. 5 shows a schematic diagram of attachment positions of the adhesive tape on the positive electrode plate and the negative electrode plate in an unfolded state within the same electrode assembly. As shown in FIG. 5, the adhesive tape 001 can be attached to a position 512 where the positive electrode tab 31 faces the negative electrode plate 40, a position 513 where the negative electrode tab 41 faces the positive electrode plate, a position 510 adjacent to the negative electrode tab 41, or a position 511 adjacent to the positive electrode tab 31, serving as a lithium precipitation prevention tape. This can reduce the formation of lithium dendrites and reduce the possibility of lithium dendrites piercing the separator and directly contacting the positive electrode plate, thereby extending the service life of the electrochemical apparatus and improving the safety performance of the electrochemical apparatus. For ease of understanding, as shown in FIG. 6, a three-dimensional rectangular coordinate system is established, where a width direction of an electrode assembly 002 is taken as a Y direction, a length direction of the electrode assembly 002 is taken as an X direction, and a thickness direction of the electrode assembly 002 is taken as a Z direction. In some embodiments of this application, as shown in FIG. 6 to FIG. 8, the adhesive tape 001 can be attached to a head 591 and a tail 592 of the electrode assembly 002, serving as a winding tape, to reduce the possibility of dangerous conditions such as short circuits in the electrochemical apparatus caused by shrinkage of the separator when the electrochemical apparatus drops or receives an impact. In some embodiments of this application, for example, as shown in FIG. 6 and FIG. 7, the adhesive tape 001 can be attached at a tail end 58 of the electrode assembly 002 along the length direction X of the electrode assembly 002, serving as a termination tape, to constrain the electrode assembly 002 and reduce the possibility of the electrode assembly 002 becoming structurally loose when the electrode assembly drops or receives an impact, thereby improving the safety performance of the electrochemical apparatus. It can be understood that, as shown in FIG. 9, the tail end 58 may also be located at a side of the electrode assembly 002. In some embodiments of this application, as shown in FIG. 6 and FIG. 8, the electrode assembly 002 has a surface A provided with the tail end 58 and another surface B opposite the surface A along the thickness direction Z of the electrode assembly 002. The adhesive tape 001 may also be attached to a middle position 520 on the another surface B of the electrode assembly 002, serving as a vertical tape or a back tape, to bond the electrode assembly 002 to the packaging case, thereby making the electrode assembly 002 and the packaging case form an integral unit. This reduces the possibility of shifting of the electrode assembly when the electrochemical apparatus drops or receives an impact, and reduces the risk of failure of the electrochemical apparatus due to the shifting of the electrode assembly, thereby improving the safety performance and service life of the electrochemical apparatus.

In some embodiments of this application, the structure of the electrode assembly is a stacked structure, and the electrode assembly includes a plurality of tabs. The tabs can be one positive electrode tab and one negative electrode tab respectively extending from each layer of the positive electrode plate and the negative electrode plate, resulting in an electrode assembly of a stacked structure containing multiple groups of positive electrode tabs and negative electrode tabs, and then the tabs are respectively welded to a metal sheet via transfer welding to lead out the positive electrode tab and the negative electrode tab. This application imposes no specific limitation on an attachment position of the adhesive tape described in any of the foregoing embodiments in the electrode assembly of the stacked structure, as long as the objectives of this application can be achieved. For example, in some embodiments of this application, the adhesive tape can be attached to a joint between the positive electrode tab and the positive electrode plate, and/or attached to a joint between the negative electrode tab and the negative electrode plate, serving as a tab protection tape, thereby reducing a risk of weld point tearing or tab breakage during a drop of the electrochemical apparatus. In some embodiments of this application, the adhesive tape can be attached to one or more of a side, a head, and a tail of the electrode assembly to fix the separator, thereby reducing the risk of short-circuit failure of the electrochemical apparatus due to separator shrinkage.

This application imposes no specific limitation on an attachment area of the adhesive tape at the aforementioned positions, and persons skilled in the art can select according to actual needs, as long as the objectives of this application can be achieved.

In this application, the aforementioned “tab” typically refers to a metal conductor extending from the positive electrode plate or the negative electrode plate, used for series or parallel connection with other parts of the electrochemical apparatus. The positive electrode tab extends from the positive electrode plate, and the negative electrode tab extends from the negative electrode plate. This application imposes no specific limitation on a material of the tab, as long as the objectives of this application can be achieved. For example, tab materials well known in the art can be used, such as aluminum tabs, copper tabs, nickel tabs, and nickel-plated copper tabs.

The electrochemical apparatus of this application further includes an electrolyte. This application imposes no specific limitation on a type of the electrolyte, as long as the objectives of this application can be achieved. For example, after at least one of ethylene carbonate (also known as vinyl carbonate, abbreviated as EC), propylene carbonate (PC), diethyl carbonate (DEC), ethyl propionate (EP), ethyl methyl carbonate (EMC), dimethyl carbonate (DMC), or fluoroethylene carbonate (FEC) was mixed at a certain mass ratio to obtain an organic solution, a lithium salt is added and dissolved in the organic solution, and the mixture is mixed uniformly. The “mass ratio” is not particularly limited in this application, as long as the objectives of this application can be achieved. The type of the lithium salt is not limited in this application, as long as the objectives of this application can be achieved. For example, the lithium salt may include at least one of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, lithium bis(oxalato)borate (LiBOB), or lithium difluoroborate. The concentration of the lithium salt in the electrolyte is not particularly limited in this application, as long as the objectives of this application can be achieved. For example, the concentration of the lithium salt ranges from 0.5 mol/L to 3.0 mol/L.

The electrochemical apparatus of this application is not particularly limited and may include but is not limited to a lithium metal secondary battery, a lithium-ion secondary battery (lithium-ion battery), a sodium-ion secondary battery, a lithium polymer secondary battery, or a lithium-ion polymer secondary battery.

A process for preparing the electrochemical apparatus is well known to persons skilled in the art, and is not particularly limited in this application. For example, the process may include but is not limited to the following steps: stacking a positive electrode plate, a separator, and a negative electrode plate in sequence; performing operations such as winding and folding on the stacked product as needed to obtain an electrode assembly of a wound structure; and placing the electrode assembly in a packaging case, injecting the electrolyte into the packaging case, and sealing the packaging case to obtain the electrochemical apparatus; or, stacking a positive electrode plate, a separator, and a negative electrode plate in sequence, then fixing four corners of the stacked structure with a tape to obtain an electrode assembly of a stacked structure, placing the electrode assembly in a packaging case, injecting the electrolyte into the packaging case, and sealing the packaging case to obtain the electrochemical apparatus. In addition, if necessary, an over-current protection element, a guide plate, and the like may be placed in the packaging case to prevent pressure rise, over-charging, and over-discharging in the electrochemical apparatus.

According to a fourth aspect of this application, an electric apparatus is provided, including the electrochemical apparatus described in any of the foregoing embodiments. Therefore, the electric apparatus exhibits good performance, such as good safety performance and long service life.

The electric apparatus is not particularly limited in this application, and may include but is not limited to a notebook computer, a pen-input computer, a mobile computer, an e-book player, a portable phone, a portable fax machine, a portable copier, a portable printer, a headset, a video recorder, a liquid crystal display television, a portable cleaner, a portable CD player, a mini disc, a transceiver, an electronic notebook, a calculator, a memory card, a portable recorder, a radio, a backup power supply, a motor, an automobile, a motorcycle, an assisted bicycle, a bicycle, a lighting fixture, a toy, a game console, a clock, an electric tool, a flashlight, a camera, a large household storage battery, and a lithium-ion capacitor.

The following describes some embodiments of this application more specifically by using examples and comparative examples. Various tests and evaluations are performed in the following methods.

### Test Methods and Devices:

### Initial Adhesion Force Test:

An adhesive tape with a size of 15 mm×150 mm from each example or comparative example was attached to a steel plate and pressed three times with a 2 kg roller. Under conditions of 23° C.±3° C. and relative humidity (RH)=50%±10%, a GoTech tensile machine was used to test the adhesive tape at a speed of 200 mm/min, and an average value of a section with a length of 50 mm after stabilization was taken. Initial adhesion force (N/m)=test value/15×1000.

### Adhesive Strength Test

Test standard: GB/T 2792-2014 peel force.

A GoTech tensile machine was used to test the adhesive strength of the adhesive tape from each example or comparative example at a 180° angle.

The adhesive tape from each example or comparative example was attached to an Al foil and cut into strip samples with a size of 20 mm×60 mm.

After each sample was hot-pressed at 85° C. and 1 MPa for 40 min and soaked in an electrolyte, along a length direction of the sample, a surface of the Al foil was adhered to a steel plate using 5000NS double-sided tape, with an adhesion length of no less than 40 mm.

The steel plate was fixed at a corresponding position of the GoTech tensile machine, and an end of the sample that was not attached to the steel plate was pulled up. The electrode plate sample was clamped either via a connector or directly in a chuck, with the pulled-up portion of the sample forming a 180° angle with the steel plate in space. The chuck pulled the sample at a speed of 5±0.2 mm/s, and an average tensile force in a stable region was measured and recorded as the adhesive strength.

### Puncture Resistance Test:

The adhesive tape from each example or comparative example was tested for puncture resistance under the following conditions.

Needle diameter: 1 mm; needle tip radius: 0.5 mm; pressing speed: 50 mm/min; and adhesive tape width: 15 mm/needle.

In a direction perpendicular to the adhesive tape, the needle pierced through the adhesive tape at a pressing speed of 50 mm/min, and a maximum force required during this process was recorded as the puncture resistance of the adhesive tape. Six parallel samples of the adhesive tape from each example and comparative example were selected, and an average value was taken as the puncture resistance.

### Swelling Thickness A−B Test:

An adhesive tape with an original thickness B was attached to an Al foil, soaked in a lithium-salt-free electrolyte at 85° C. for 24 h, and then taken out. After the electrolyte was wiped off, a thickness A at an edge of the adhesive tape was measured within 5 min using a micrometer with a head diameter≥Φ4 mm. A swelling thickness value of the adhesive tape was calculated as A−B.

The lithium-salt-free electrolyte was prepared by mixing ethylene carbonate, propylene carbonate, diethyl carbonate, and ethyl propionate at a mass ratio of 30:10:30:30.

Six adhesive tape samples from each example and comparative example were measured to obtain corresponding values of A−B, and an average value was calculated as an average swelling thickness of the adhesive tape, which was recorded as the final swelling thickness A−B of the adhesive tape.

### Adhesive Overflow Test:

One adhesive tape strip with a size 15 mm×26 mm from each example or comparative example was attached between two PET sheets with dimensions of width×length×thickness=15 mm×26 mm×50 m. After hot-pressing at 85° C. and a pressure of 1 MPa for 1 h, an adhesive overflow width beyond a corresponding edge of the PET along each side of the adhesive tape in a width direction was measured, and a larger width was recorded as W. Six adhesive tape strips from each example and comparative example were tested, and an average value of W for the six strips was taken as a maximum single-side adhesive overflow width of the adhesive tape.

### Drop Test:

A lithium-ion battery prepared in each example or comparative example was charged at a constant current of 0.5 C to a full charge voltage at room temperature, and then charged at a constant voltage until a current reached 0.05 C, so that the battery was in a fully charged state. Subsequently, a voltage of the lithium-ion battery was adjusted to a 68% state of charge (SOC), and the voltage and internal resistance were measured to ensure the voltage of the lithium-ion battery ranged from 3.94 V to 3.99 V. A constant voltage testing machine and a dedicated metal or plastic mold for a drop test were used, the lithium-ion battery was placed in the constant voltage testing machine, air compression was immediately performed after the constant voltage testing machine was in close contact with the lithium-ion battery, and a 5 kg pressing block was used to press the lithium-ion battery for 7s. Subsequently, the battery was left standing for 1 h, and the voltage and internal resistance were measured again. Whether there were appearance damage, electrolyte leakage, swelling, corrosion, and the like in the lithium-ion battery was checked; after that, a cover plate of the dedicated metal or plastic mold for the drop test was closed; and screws were fastened to complete preparation for the drop test.

According to the following sequence, the lithium-ion battery was dropped freely from a height of 1.8 meters in six directions: head->tail->head right corner->tail right corner->head left corner->tail left corner, with an angle between the lithium-ion battery and the ground of 450±15°, and this was repeated for 7 rounds. After each round of test, if electrolyte leakage, heat generation, smoking, fire, or a voltage drop greater than 50 mV was detected, the drop test was stopped. After the drop test, the lithium-ion battery was left standing at room temperature for 24 h, and then the voltage and internal resistance were measured.

Pass criteria for the drop test: no fire, no electrolyte leakage, and a voltage drop<50 mV after 24 h indicate no failure.

One hundred lithium-ion batteries prepared in each example or comparative example were tested, where failure rate=number of failures/total number of tested batteries×100%.

### Roller Test:

After the lithium-ion battery was left standing at 25° C. for 60 min, the voltage, internal resistance, and capacity measured. The lithium-ion battery was then placed in a fixture, with a roller height set to 1 m. A contact surface between the roller and the lithium-ion battery was a metal contact surface, and rolling was performed at 5 min per cycle for a total of 500 cycles. Every 100 cycles, the voltage and internal resistance were tested and recorded, and the appearance was inspected and photographed.

Judgment criteria: no smoking, no fire, no explosion, no electrolyte leakage, a voltage drop (also referred to as voltage)<50 mV, and an internal resistance<18 mΩ indicate no failure.

One hundred lithium-ion batteries prepared in each example or comparative example were tested, where failure rate=number of failures/total number of tested batteries×100%.

### Example 1-1

### <Preparation of Negative Electrode Plate>

A negative electrode active material graphite powder, a conductive agent conductive carbon black (Super P), and a binder styrene-butadiene rubber (SBR) were mixed at a mass ratio of 96:1.5:2.5, then deionized water was added as a solvent to prepare a negative electrode slurry with a solid content of 70 wt %, and the mixture was stirred uniformly. The negative electrode slurry was uniformly applied onto one surface of a negative electrode current collector copper foil with a thickness of 8 m, and dried at 110° C. to obtain a negative electrode plate with a single surface coated with a negative electrode active material layer with a thickness of 130 m. Subsequently, the above steps were repeated on the other surface of the negative electrode current collector copper foil to obtain a negative electrode plate coated with the negative electrode active material layer on both sides. After cold pressing, cutting, and slitting, drying was performed in vacuum at 120° C. for 1 h to obtain a 78 mm×875 mm negative electrode plate. A negative electrode tab was welded and connected to the negative electrode plate, and a material of the negative electrode tab was nickel-plated copper.

### <Preparation of Positive Electrode Plate>

A positive electrode active material lithium cobalt oxide (LiCoO₂), a conductive agent nano conductive carbon black, and a binder polyvinylidene fluoride (PVDF) were mixed at a mass ratio of 97.5:1.0:1.5, and N-methylpyrrolidone (NMP) was added as a solvent to prepare a positive electrode slurry with a solid content of 75 wt %, and the mixture was stirred uniformly. The positive electrode slurry was uniformly applied onto one surface of a positive electrode current collector aluminum foil with a thickness of 9 m, and dried at 90° C. to obtain a positive electrode plate with a single surface coated with a positive electrode active material layer with a thickness of 110 m. Then, the foregoing steps were repeated on the other surface of the positive electrode current collector aluminum foil to obtain a positive electrode plate coated with the positive electrode active material layer on both sides. After cold pressing, cutting, and slitting, drying was performed in vacuum at 120° C. for 1 h to obtain a 74 mm×867 mm positive electrode plate. A positive electrode tab was welded and connected to the positive electrode plate, and a material of the positive electrode tab was aluminum.

### <Preparation of Electrolyte>

In a dry argon atmosphere, ethylene carbonate (EC), ethyl methyl carbonate (EMC), and diethyl carbonate (DEC) were mixed at a mass ratio of 30:50:20 to obtain an organic solvent. Then, a lithium salt lithium hexafluorophosphate was added and dissolved in the organic solvent and mixed uniformly to obtain an electrolyte with a lithium salt concentration of 1.15 mol/L.

### <Preparation of Separator>

Alumina and polyvinylidene fluoride (abbreviated as PVDF, with a weight-average molecular weight of 530000) were mixed at a mass ratio of 90:10 and dissolved in deionized water to form a ceramic slurry with a solid content of 50 wt %. Subsequently, the ceramic slurry was uniformly applied onto one surface of a porous substrate (polyethylene with a thickness of 7 m, an average pore diameter of 0.073 m, and a porosity of 26%) using a micro-gravure coating method, followed by drying to obtain a double-layer structure with a ceramic coating and the porous substrate, where a thickness of the ceramic coating was 50 m.

PVDF and methyl polyacrylate (with a weight-average molecular weight of 320000) were mixed at a mass ratio of 96:4 and dissolved in deionized water to form a polymer slurry with a solid content of 50 wt %. Then, the polymer slurry was uniformly applied onto two surfaces of the double-layer structure with the ceramic coating and the porous substrate using the micro-gravure coating method, followed by drying to obtain a separator, where a thickness of a single coating formed by the polymer slurry was 2 m.

### <Preparation of Adhesive Tape>

As shown in FIG. 1, an adhesive tape 001 included a substrate layer 10 and an adhesive layer 20 disposed on one surface 10a of the substrate layer 10. The adhesive layer was formed by a binder. The binder included SIS (with a mass ratio of styrene to isoprene of 15:85), an acrylic resin butyl methacrylate, polyethylene glycol, a tackifying resin terpene resin (with a weight-average molecular weight of 950), an antioxidant pentaerythritol tetrakis(3,5-di-tert-butyl-4-hydroxy)phenylpropionate, and an additive carbon black. Based on a mass of the binder, a sum W₁ of mass percentages of the SIS and the acrylic resin butyl methacrylate was 65% (with a mass ratio of the acrylic resin butyl methacrylate to the SIS of 1.5:1), a mass percentage W₂ of the polyethylene glycol was 15%, a mass percentage W₃ of the tackifying resin was 15%, a mass percentage W₄ of the antioxidant was 2.5%, and a mass percentage W₅ of the additive was 2.5%. A weight-average molecular weight Mw₁₋₁ of the SIS was 80000, a weight-average molecular weight Mw₁₋₂ of the acrylic resin was 100000, and a weight-average molecular weight Mw₂ of the polyethylene glycol was 300. A material of the substrate layer was PET (with a weight-average molecular weight of 25000). A thickness T of the adhesive tape was 16 m, a thickness T₁ of the adhesive layer was 6 m, and a thickness T₂ of the substrate layer was 10 m.

### <Preparation of Lithium-Ion Battery>

As shown in FIG. 9, the positive electrode plate 30, the separator 50, and the negative electrode plate 40 prepared above were stacked in sequence, with the separator 50 positioned between the positive electrode plate 30 and the negative electrode plate 40 for isolation, and wound to obtain an electrode assembly 002 of a wound structure. After an adhesive layer of the adhesive tape 001 was attached to an outer surface of the electrode assembly 002 at a tail end 58 as shown in FIG. 9, the electrode assembly was placed in an aluminum-plastic film packaging case, and moisture was removed at 80° C. The prepared electrolyte was injected, and after vacuum sealing, standing, formation, and degassing processes, a lithium-ion battery was obtained.

### Example 1-2 to Example 1-4

These examples were the same as Example 1-1 except that related preparation parameters were adjusted according to Table 1.

### Example 2-1 to Example 2-12

These examples were the same as Example 1-3 except that related preparation parameters were adjusted according to Table 1.

### Example 3-1 to Example 3-8

These examples were the same as Example 1-3 except that related preparation parameters were adjusted according to Table 1.

### Example 4-1 to Example 4-7

These examples were the same as Example 1-3 except that related preparation parameters were adjusted according to Table 1.

### Comparative Example 1 to Comparative Example 4

These examples were the same as Example 1-1 except that related preparation parameters were adjusted according to Table 1.

The preparation parameters and performance parameters of examples and comparative examples are shown in Table 1 and Table 4.

TABLE 1

| | | | | | Com- | Com- | Com- | Com- |
|---|---|---|---|---|---|---|---|---|
| | Example | Example | Example | Example | parative | parative | parative | parative |
| | 1-1 | 1-2 | 1-3 | 1-4 | Example 1 | Example 2 | Example 3 | Example 4 |
| Roller failure rate (%) | 0 | 0 | 0 | 0 | 20 | 10 | 20 | 30 |
| Drop failure rate (%) | 3 | 0 | 0 | 0 | 20 | 10 | 10 | 50 |
| Maximum single-side adhesive | 0.19 | 0.23 | 0.39 | 0.48 | 0.21 | 0.97 | 1.13 | 1.75 |
| overflow width (mm) | | | | | | | | |
| A-B (μm) | 0.9 | 1.1 | 1.2 | 1.4 | 0.8 | 2.2 | 2.5 | 3.1 |
| Puncture resistance (N) | 5.12 | 5.27 | 5.13 | 5.23 | 5.14 | 5.39 | 5.31 | 5.25 |
| Adhesive strength (N/m) | 108 | 234 | 242 | 321 | 47 | 436 | 475 | 31 |
| Initial adhesion force (N/m) | 171 | 265 | 332 | 426 | 99 | 545 | 589 | 185 |
| W₅ (%) | 2.5 | 5 | 4 | 2 | 8 | 1 | 1 | 4 |
| W₄ (%) | 2.5 | 5 | 2 | 3 | 8 | 1 | 1 | 2 |
| W₃ (%) | 15 | 10 | 8 | 5 | 4 | 4 | 4 | 8 |
| W₂ (%) | 15 | 7 | 8 | 5 | 25 | 4 | 0 | 8 |
| W₁ (%) | 65 | 73 | 78 | 85 | 55 | 90 | 94 | 78 |
| | | | | | | | | (containing |
| | | | | | | | | only acrylic |
| | | | | | | | | resin) |

From Examples 1-1 to 1-4 and Comparative Examples 1 to 4, it can be seen that the safety performance and service life of the lithium-ion battery vary with changes in the composition of the binder. In Examples 1-1 to 1-4, the binder includes a styrene-isoprene-styrene block copolymer, an acrylic resin, and polyethylene glycol, with mass percentages of the styrene-isoprene-styrene block copolymer, the acrylic resin, and the polyethylene glycol within the ranges provided in this application. The binder in Examples 1-1 to 1-4 forms an adhesive layer to prepare an adhesive tape, and the adhesive tape has initial adhesion force, adhesive strength, puncture resistance, a value of A−B, and a maximum single-side adhesive overflow width within the ranges provided in this application, indicating that the electrolyte resistance and adhesive properties of the adhesive tape are improved. When the adhesive tape is applied to a lithium-ion battery, the drop failure rate (failure rate in the drop test) and the roller failure rate (failure rate in the roller test) indicate that the lithium-ion battery has good safety performance and a longer service life. In Comparative Examples 1 to 4, the mass percentages of the styrene-isoprene-styrene block copolymer, the acrylic resin, and the polyethylene glycol in the binder are not within the ranges provided in this application, or the binder does not contain all of the styrene-isoprene-styrene block copolymer, the acrylic resin, and the polyethylene glycol. The binder in Comparative Examples 1 to 4 forms an adhesive layer to prepare an adhesive tape, and the initial adhesion force, adhesive strength, puncture resistance, value of A−B, and maximum single-side adhesive overflow width of the adhesive tape do not all fall within the ranges of this application, indicating that the electrolyte resistance and adhesive properties of the adhesive tape are not both improved. When the adhesive tapes from Comparative Examples 1 to 4 are applied to a lithium-ion battery, the drop failure rate and roller failure rate are not reduced, indicating that the lithium-ion battery does not have good safety performance and a longer service life. Specifically, in Comparative Example 1, a percentage W₁ of the SIS and acrylic resin is low, and the adhesive tape cannot provide a sufficient initial adhesion force, resulting in poor constraint force. During drop and roller tests of the lithium-ion battery, the electrode assembly is prone to shifting, leading to a loose structure, causing failures such as electrolyte leakage and fire, and reducing the drop failure rate and roller failure rate of the lithium-ion battery, thus degrading the safety performance of the lithium-ion battery. In Comparative Example 4, the adhesive tape contains only acrylic resin without SIS, failing to form a stable bicontinuous structure. Although its initial adhesion force is large, the adhesive tape is not resistant to electrolyte, with significant performance degradation after being soaked in electrolyte, and it cannot provide sufficient constraint, reducing the drop failure rate and roller failure rate of the lithium-ion battery and thus degrading the safety performance of the lithium-ion battery. In Comparative Examples 2 and 3, a percentage W1 of the SIS and acrylic resin is excessively high, resulting in an adhesive strength of the adhesive tape exceeding the range provided in this application. Excessive adhesive strength of the adhesive tape, during drop or roller processes, causes relative motion between the electrode assembly and the packaging case, causing an outermost copper foil or copper foil of the electrode assembly to be prone to tearing, forming short-circuit points, resulting in failures such as fire, smoking, and explosion in the lithium-ion battery, and reducing the drop failure rate and roller failure rate of the lithium-ion battery, thus degrading the safety performance of the lithium-ion battery.

TABLE 2

| | Example 1-3 | Example 2-1 | Example 2-2 | Example 2-3 | Example 2-4 | Example 2-5 |
|---|---|---|---|---|---|---|
| Roller failure rate (%) | 0 | 0 | 0 | 2 | 10 | 0 |
| Drop failure rate (%) | 0 | 1 | 0 | 0 | 0 | 0 |
| Maximum single-side | 0.39 | 0.28 | 0.35 | 0.67 | 0.21 | 0.75 |
| adhesive overflow | | | | | | |
| width (mm) | | | | | | |
| A-B (μm) | 1.2 | 1.0 | 1.1 | 1.8 | 0.9 | 2.1 |
| Puncture resistance | 5.13 | 5.38 | 5.25 | 5.05 | 5.15 | 5.07 |
| (N) | | | | | | |
| Adhesive strength | 262 | 210 | 235 | 330 | 93 | 378 |
| (N/m) | | | | | | |
| Initial adhesion force | 332 | 256 | 305 | 397 | 172 | 466 |
| (N/m) | | | | | | |
| Type of additive | Carbon black | Carbon black | Carbon black | Carbon black | Carbon black | Carbon black |
| Type of antioxidant | Pentaerythritol | Pentaerythritol | Pentaerythritol | Pentaerythritol | Pentaerythritol | Pentaerythritol |
| | tetrakis(3,5-di- | tetrakis(3,5-di- | tetrakis(3,5-di- | tetrakis(3,5-di- | tetrakis(3,5-di- | tetrakis(3,5-di- |
| | tert-butyl-4- | tert-butyl-4- | tert-butyl-4- | tert-butyl-4- | tert-butyl-4- | tert-butyl-4- |
| | hydroxy)phenyl- | hydroxy)phenyl- | hydroxy)phenyl- | hydroxy)phenyl- | hydroxy)phenyl- | hydroxy)phenyl- |
| | propionate | propionate | propionate | propionate | propionate | propionate |
| Type of tackifying | Terpene resin | Terpene resin | Terpene resin | Terpene resin | Terpene resin | Terpene resin |
| resin | | | | | | |
| Type of acrylic resin | Butyl | Butyl | Butyl | Butyl | Butyl | Butyl |
| | methacrylate | methacrylate | methacrylate | methacrylate | methacrylate | methacrylate |
| Mass ratio of acrylic | 1.5:1 | 1:1 | 1.2:1 | 2:1 | 0.8:1 | 2.2:1 |
| resin to SIS | | | | | | |

| | Example 2-6 | Example 2-7 | Example 2-8 | Example 2-9 | Example 2-10 |
|---|---|---|---|---|---|
| Roller failure rate (%) | 0 | 0 | 0 | 0 | 0 |
| Drop failure rate (%) | 0 | 0 | 0 | 0 | 0 |
| Maximum single-side | 0.42 | 0.46 | 0.41 | 0.45 | 0.42 |
| adhesive overflow | | | | | |
| width (mm) | | | | | |
| A-B (μm) | 1.2 | 1.2 | 1.1 | 1.2 | 1.2 |
| Puncture resistance | 5.26 | 5.0 | 5.43 | 5.08 | 5.27 |
| (N) | | | | | |
| Adhesive strength | 228 | 230 | 252 | 204 | 250 |
| (N/m) | | | | | |
| Initial adhesion force | 315 | 337 | 341 | 311 | 330 |
| (N/m) | | | | | |
| Type of additive | Carbon black | Carbon black | Titanium dioxide | Carbon black | Carbon black |
| Type of antioxidant | Pentaerythritol | Distearyl | Pentaerythritol | Pentaerythritol | Pentaerythritol tetrakis(3,5- |
| | tetrakis(3,5-di- | thiodipropionate | tetrakis(3,5-di-tert- | tetrakis(3,5-di-tert-butyl- | di-tert-butyl-4- |
| | tert-butyl-4- | | butyl-4- | 4- | hydroxy)phenylpropionate |
| | hydroxy)phenyl- | | hydroxy)phenyl- | hydroxy)phenylpropionate | |
| | propionate | | propionate | | |
| Type of tackifying | C5 petroleum | Terpene resin | Terpene resin | Terpene resin | Terpene resin |
| resin | resin (with a | | | | |
| Type of acrylic resin | Butyl | Butyl | Butyl methacrylate | Methyl methacrylate | Butyl methacrylate |
| | methacrylate | methacrylate | | | |
| Mass ratio of acrylic | 1.5:1 | 1.5:1 | 1.5:1 | 1.5:1 | 1.4:1 |
| resin to SIS | | | | | |

| | Example 2-11 | Example 2-12 |
|---|---|---|
| Roller failure rate (%) | 0 | 0 |
| Drop failure rate (%) | 0 | 0 |
| Maximum single-side | 0.44 | 0.5 |
| adhesive overflow | | |
| width (mm) | | |
| A-B (μm) | 1.3 | 1.6 |
| Puncture resistance | 5.43 | 5.45 |
| (N) | | |
| Adhesive strength | 265 | 286 |
| (N/m) | | |
| Initial adhesion force | 340 | 362 |
| (N/m) | | |
| Type of additive | Carbon black | Carbon black |
| Type of antioxidant | Pentaerythritol | Pentaerythritol tetrakis(3,5-di-tert-butyl-4- |
| | tetrakis(3,5-di-tert- | hydroxy)phenylpropionate |
| | butyl-4- | |
| | hydroxy)phenyl- | |
| | propionate | |
| Type of tackifying | Terpene resin | Terpene resin |
| resin | | |
| Type of acrylic resin | Butyl methacrylate | Butyl methacrylate |
| Mass ratio of acrylic | 1.6:1 | 1.8:1 |
| resin to SIS | | |

The mass ratio of the acrylic resin to SIS in the adhesive tape typically also affects the safety performance and service life of the lithium-ion battery. From Example 1-3 and Examples 2-1 to 2-5, it can be seen that SIS has strong cohesive force and forms hydrogen bonds with the acrylic resin, maintaining adhesive properties of the entire system. In Example 2-4, the mass ratio of the acrylic resin to SIS in the adhesive tape is small, resulting in lower adhesive strength compared to other examples in Table 2, thus leading to a higher roller failure rate of the battery. In Example 2-5, the mass ratio of the acrylic resin to SIS in the adhesive tape is large, and a maximum single-side adhesive overflow width of the adhesive tape is significantly greater than that of other examples in Table 2, affecting battery processing precision. Excessive adhesive overflow can easily bind active material particles, forming contaminants and posing electrochemical and safety risks to the battery. It is noteworthy that, although Examples 2-4 and 2-5 are not preferred embodiments of this application, their overall performance is still superior to that of Comparative Examples 1 to 4. In Examples 1-3, 2-1 to 2-3, and 2-10 to 2-12, the adhesive tape prepared using a binder with a mass ratio of the acrylic resin to SIS within the range provided in this application exhibits appropriate initial adhesion force, adhesive strength, and puncture resistance, with a smaller value of A−B and maximum single-side adhesive overflow width, indicating that the electrolyte resistance and adhesive properties of the adhesive tape are improved. When the adhesive tape is applied to a lithium-ion battery, the drop failure rate and the roller failure rate are reduced, indicating that the lithium-ion battery has good safety performance and a longer service life. In addition, among Examples 1-3, 2-1 to 2-3, and 2-10 to 2-12, the initial adhesion force in Example 2-1 is smaller, posing a certain risk of drop failure; the maximum single-side adhesive overflow width and swelling degree of the adhesive tape in Example 2-3 are larger, which is detrimental to structural stability and safety of the battery, with adhesive overflow contributing to a roller failure rate of 2% in Example 2-3; and Examples 1-3, 2-10, and 2-11 exhibit optimal comprehensive performance in terms of adhesive strength, resistance to adhesive overflow, and resistance to swelling.

Types of the acrylic resin, tackifying resin, antioxidant, and additive typically also affect the safety performance and service life of the lithium-ion battery. From Example 1-3 and Examples 2-6 to 2-9, it can be seen that the adhesive tape prepared using a binder with types of the acrylic resin, tackifying resin, antioxidant, and additive within the range provided in this application exhibits appropriate initial adhesion force, adhesive strength, and puncture resistance, with a smaller value of A−B and maximum single-side adhesive overflow width, indicating that the electrolyte resistance and adhesive properties of the adhesive tape are improved. When the adhesive tape is applied to a lithium-ion battery, the drop failure rate and the roller failure rate are reduced, indicating that the lithium-ion battery has good safety performance and a longer service life.

TABLE 3

| | Example | Example | Example | Example | Example | Example | Example | Example | Example |
|---|---|---|---|---|---|---|---|---|---|
| | 1-3 | 3-1 | 3-2 | 3-3 | 3-4 | 3-5 | 3-6 | 3-7 | 3-8 |
| Roller failure | 0 | 0 | 10 | 0 | 0 | 0 | 0 | 10 | 10 |
| rate (%) | | | | | | | | | |
| Drop failure | 0 | 0 | 0 | 0 | 0 | 0 | 0 | 10 | 0 |
| rate (%) | | | | | | | | | |
| Maximum | 0.39 | 0.41 | 0.48 | 0.37 | 0.35 | 0.58 | 0.72 | 0.79 | 0.27 |
| single-side | | | | | | | | | |
| adhesive | | | | | | | | | |
| overflow | | | | | | | | | |
| width (mm) | | | | | | | | | |
| A-B (μm) | 1.2 | 1.2 | 1.1 | 1.1 | 1.1 | 1.3 | 1.4 | 1.8 | 0.8 |
| Puncture | 5.13 | 5.17 | 5.04 | 5.15 | 5.19 | 5.13 | 5.05 | 5.08 | 5.21 |
| resistance (N) | | | | | | | | | |
| Adhesive | 242 | 195 | 132 | 245 | 25 | 232 | 220 | 77 | 387 |
| strength (N/m) | | | | | | | | | |
| Initial | 332 | 275 | 240 | 330 | 325 | 340 | 355 | 164 | 492 |
| adhesion force | | | | | | | | | |
| (N/m) | | | | | | | | | |
| Mw₂ | 300 | 4000 | 8500 | 300 | 300 | 300 | 300 | 200 | 10000 |
| Mw₁₋₂ | 100000 | 100000 | 100000 | 100000 | 100000 | 150000 | 200000 | 80000 | 220000 |
| Mw₁₋₁ | 80000 | 80000 | 80000 | 100000 | 120000 | 80000 | 80000 | 70000 | 130000 |

The weight-average molecular weight Mw₂ of the polyethylene glycol, the weight-average molecular weight Mw₁₋₁ of the styrene-isoprene-styrene block copolymer, and the weight-average molecular weight Mw₁₋₂ of the acrylic resin typically also affect the safety performance and service life of the lithium-ion battery. From Example 1-3, Example 3-1, and Example 3-2, it can be seen that as the weight-average molecular weight Mw₂ of the polyethylene glycol increases, the initial adhesion force and adhesive strength of the adhesive tape decrease, but are still within the ranges provided in this application. This is because, when the molecular weight of the polyethylene glycol is within the range provided in this application, it can be effectively dissolved into a framework formed by SIS and the acrylic resin, wetting the entire binder system and providing good flowability after hot melting of the binder. However, when the weight-average molecular weight Mw₂ of the polyethylene glycol exceeds the range provided in this application, it becomes entangled with other polymer chains in the system, reducing a plasticizing effect of the molecules and weakening the adhesive strength. From Example 1-3, Example 3-3, and Example 3-4, it can be seen that changes in the weight-average molecular weight Mw₁₋₁ of the styrene-isoprene-styrene block copolymer have a greater impact on the initial adhesion force and the adhesive strength compared to other performance parameters. From Example 1-3, Example 3-5, and Example 3-6, it can be seen that changes in the weight-average molecular weight Mw₁₋₂ of the acrylic resin have a greater impact on the value of A−B and the maximum single-side adhesive overflow width compared to other performance parameters. The adhesive tape prepared using a binder with the weight-average molecular weight Mw₂ of the polyethylene glycol, the weight-average molecular weight Mw₁₋₁ of the styrene-isoprene-styrene block copolymer, and the weight-average molecular weight Mw₁₋₂ of the acrylic resin within the ranges provided in this application exhibits appropriate initial adhesion force, adhesive strength, and puncture resistance, with a smaller value of A−B and maximum single-side adhesive overflow width, indicating that the electrolyte resistance and adhesive properties of the adhesive tape are improved. When the adhesive tape is applied to a lithium-ion battery, the drop failure rate and the roller failure rate are reduced, indicating that the lithium-ion battery has good safety performance and a longer service life. In Example 3-7, the weight-average molecular weight Mw₂ of the polyethylene glycol, the weight-average molecular weight Mw₁₋₁ of the styrene-isoprene-styrene block copolymer, and the weight-average molecular weight Mw₁₋₂ of the acrylic resin are below the ranges provided in this application, resulting in smaller initial adhesion force and adhesive strength of the adhesive tape compared to those in Examples 1-3 and 3-1 to 3-6 and weakened constraint force of the adhesive tape. Therefore, during drop and roller tests of the lithium-ion battery, the electrode assembly is prone to shifting, leading to a loose structure and increasing the possibility of failures such as electrolyte leakage and fire. However, as compared to Comparative Examples 1 to 4, the value of A−B and the maximum single-side adhesive overflow width in Example 3-7 are smaller, and the adhesive tape exhibits good electrolyte resistance. With lower drop failure rate and roller failure rate, the lithium-ion battery demonstrates an extended service life while maintaining good safety performance. In Example 3-8, the weight-average molecular weight Mw₂ of the polyethylene glycol, the weight-average molecular weight Mw₁₋₁ of the styrene-isoprene-styrene block copolymer, and the weight-average molecular weight Mw₁₋₂ of the acrylic resin exceed the ranges provided in this application, resulting in larger initial adhesion force and adhesive strength of the adhesive tape prepared using them as compared to the adhesive tape in Examples 1-3 and 3-1 to 3-6. During drop and roller tests of the lithium-ion battery, tearing of an outermost copper foil of the electrode assembly increases the possibility of failures such as fire, smoking, and explosion. However, as compared to Comparative Examples 1 to 4, the value of A−B and the maximum single-side adhesive overflow width in Example 3-8 are smaller, and the adhesive tape exhibits good electrolyte resistance. With lower drop failure rate and roller failure rate, the lithium-ion battery demonstrates an extended service life while maintaining good safety performance.

TABLE 4

| | Example | Example | Example | Example | Example | Example | Example | Example |
|---|---|---|---|---|---|---|---|---|
| | 1-3 | 4-1 | 4-2 | 4-3 | 4-4 | 4-5 | 4-6 | 4-7 |
| Roller failure | 0 | 0 | 0 | 0 | 0 | 0 | 20 | 10 |
| rate (%) | | | | | | | | |
| Drop failure | 0 | 0 | 0 | 0 | 0 | 0 | 10 | 0 |
| rate (%) | | | | | | | | |
| Maximum | 0.39 | 0.24 | 0.62 | 0.43 | 0.45 | 0.59 | 0.42 | 0.81 |
| single-side | | | | | | | | |
| adhesive | | | | | | | | |
| overflow | | | | | | | | |
| width (mm) | | | | | | | | |
| A-B (μm) | 1.2 | 1.1 | 1.3 | 1.2 | 1.2 | 1.3 | 1.1 | 1.4 |
| Puncture | 5.13 | 5.27 | 5.08 | 4.12 | 9.89 | 9.92 | 3.85 | 9.96 |
| resistance (N) | | | | | | | | |
| Adhesive | 242 | 116 | 356 | 238 | 244 | 363 | 64 | 373 |
| strength (N/m) | | | | | | | | |
| Initial adhesion | 332 | 195 | 481 | 327 | 339 | 489 | 132 | 497 |
| force (N/m) | | | | | | | | |
| T (μm) | 16 | 13 | 20 | 11 | 36 | 40 | 6 | 42 |
| T₂ (μm) | 10 | 10 | 10 | 5 | 30 | 30 | 4 | 31 |
| T₁ (μm) | 6 | 3 | 10 | 6 | 6 | 10 | 2 | 11 |

The thickness T of the adhesive tape, the thickness T₁ of the adhesive layer, and the thickness T₂ of the substrate layer typically also affect the safety performance and service life of the lithium-ion battery. From Example 1-3 and Examples 4-1 to 4-7, it can be seen that the adhesive tape with a thickness T, a thickness T₁ of the adhesive layer, and a thickness T₂ of the substrate layer within the ranges provided in this application exhibits appropriate initial adhesion force, adhesive strength, and puncture resistance, with a smaller value of A−B and maximum single-side adhesive overflow width, indicating that the electrolyte resistance and adhesive properties of the adhesive tape are improved. When the adhesive tape is applied to a lithium-ion battery, the drop failure rate and the roller failure rate are reduced, indicating that the lithium-ion battery has good safety performance and a longer service life. Specifically, in Examples 1-3, 4-1, and 4-2, as the thickness T₁ of the adhesive layer decreases, the initial adhesion force and adhesive strength of the adhesive tape decrease, and the maximum single-side adhesive overflow width decreases, indicating that the thickness T₁ of the adhesive layer significantly affects the initial adhesion force, adhesive strength, and resistance to adhesive overflow of the adhesive tape. Controlling the thickness T₁ of the adhesive layer within the range provided in this application ensures that the adhesive tape has the initial adhesion force and adhesive strength within the ranges provided in this application, and the lithium-ion battery exhibits good safety performance and a longer service life. In Examples 1-3, 4-3, and 4-4, as the thickness T₂ of the substrate layer decreases, the puncture resistance decreases, indicating that the thickness T₂ of the substrate layer significantly affects the puncture resistance. Controlling the thickness T₂ of the substrate layer within the range provided in this application ensures that the adhesive tape has the puncture resistance within the range provided in this application. When the adhesive tape is applied to components with burrs (such as nickel-plated copper tabs) in the electrode assembly, the adhesive tape can reduce the possibility of short circuits in the lithium-ion battery caused by burrs, improving the safety performance and extending the service life of the lithium-ion battery. In Example 4-6, the thickness T of the adhesive tape, the thickness T₁ of the adhesive layer, and the thickness T₂ of the substrate layer are below the ranges provided in this application, resulting in smaller initial adhesion force and adhesive strength of the adhesive tape and weakened constraint force of the adhesive tape as compared to the adhesive tapes in Examples 1-3 and 4-1 to 4-5. Therefore, during drop and roller tests of the lithium-ion battery, the electrode assembly is prone to shifting, leading to a loose structure and increasing the possibility of failures such as electrolyte leakage and fire. However, as compared to Comparative Examples 1 to 4, the value of A−B and the maximum single-side adhesive overflow width in Example 4-6 are smaller, and the adhesive tape exhibits good electrolyte resistance. With lower drop failure rate and roller failure rate, the lithium-ion battery demonstrates an extended service life while maintaining good safety performance. In Example 4-7, the thickness T of the adhesive tape, the thickness T₁ of the adhesive layer, and the thickness T₂ of the substrate layer exceed the ranges provided in this application, resulting in larger initial adhesion force and adhesive strength of the adhesive tape as compared to the adhesive tapes in Examples 1-3 and 4-1 to 4-5. During drop and roller tests of the lithium-ion battery, tearing of an outermost copper foil of the electrode assembly increases the possibility of failures such as fire, smoking, and explosion. However, as compared to Comparative Examples 1 to 4, the value of A−B and the maximum single-side adhesive overflow width in Example 4-7 are smaller, and the adhesive tape exhibits good electrolyte resistance. With lower drop failure rate and roller failure rate, the lithium-ion battery demonstrates an extended service life while maintaining good safety performance.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A binder, comprising a styrene-isoprene-styrene block copolymer, an acrylic resin, and polyethylene glycol; wherein based on a mass of the binder, a sum of mass percentages of the styrene-isoprene-styrene block copolymer and the acrylic resin ranges from 65% to 85%, and a mass percentage of the polyethylene glycol ranges from 5% to 15%.

2. The binder according to claim 1, further comprising a tackifying resin, an antioxidant, and an additive; wherein
the tackifying resin comprises at least one of rosin resin, terpene resin, C5 petroleum resin, C9 petroleum resin, or coumarone resin;
the antioxidant comprises at least one of pentaerythritol tetrakis(3,5-di-tert-butyl-4-hydroxy)phenylpropionate, n-octadecyl 3-(3,5-di-tert-butyl-4-hydroxyphenyl)propionate, tris(2,4-di-tert-butylphenyl) phosphite, bis(2,4-di-tert-butylphenyl)pentaerythritol diphosphite, distearyl thiodipropionate, bis(3,5-di-tert-butyl-4-hydroxyphenylpropionyl)hydrazine, 1,3,5-tris(3,5-di-tert-butyl-4-hydroxybenzyl)-1,3,5-triazine-2,4,6(1H,3H,5H)-trione, pentaerythritol tetrakis(3-laurylthiopropionate), or 4,6-bis(dodecylthiomethyl)-o-cresol;
the additive comprises at least one of carbon black, alumina, or titanium dioxide; and
based on a mass of the binder, a mass percentage of the tackifying resin ranges from 5% to 15%, a mass percentage of the antioxidant ranges from 2% to 5%, and a mass percentage of the additive ranges from 2% to 5%.

3. The binder according to claim 1, wherein a mass ratio of the acrylic resin to the styrene-isoprene-styrene block copolymer ranges from 1:1 to 2:1.

4. The binder according to claim 3, wherein the mass ratio of the acrylic resin to the styrene-isoprene-styrene block copolymer ranges from 1.2:1 to 1.8:1.

5. The binder according to claim 4, wherein the mass ratio of the acrylic resin to the styrene-isoprene-styrene block copolymer ranges from 1.4:1 to 1.6:1.

6. The binder according to claim 1, wherein a weight-average molecular weight of the polyethylene glycol ranges from 300 to 8500, a weight-average molecular weight of the styrene-isoprene-styrene block copolymer ranges from 80000 to 120000, and a weight-average molecular weight of the acrylic resin ranges from 100000 to 200000.

7. The binder according to claim 1, wherein the acrylic resin comprises at least one of butyl methacrylate, dimethylaminoethyl methacrylate, or methyl methacrylate.

8. An adhesive tape, comprising a substrate layer and an adhesive layer disposed on at least one surface of the substrate layer, wherein the adhesive layer comprises the binder according to claim 1; and the substrate layer comprises at least one of polyethylene terephthalate, polyimide, or polypropylene.

9. The adhesive tape according to claim 8, wherein a thickness of the adhesive tape ranges from 8 m to 40 m, a thickness of the adhesive layer ranges from 3 m to 10 m, and a thickness of the substrate layer ranges from 5 m to 30 m.

10. The adhesive tape according to claim 8, wherein an initial adhesion force of the adhesive tape ranges from 100 N/m to 500 N/m;
after the adhesive tape is soaked in a lithium-salt-free electrolyte at 85° C. for 4 h and then hot-pressed at 85° C. under a pressure of 1 MPa, an adhesive strength of the adhesive tape ranges from 50 N/m to 400 N/m, and the lithium-salt-free electrolyte is prepared by mixing ethylene carbonate, propylene carbonate, diethyl carbonate, and ethyl propionate at a mass ratio of 30:10:30:30.

11. The adhesive tape according to claim 8, wherein a puncture resistance of the adhesive tape ranges from 4 N to 10 N.

12. The adhesive tape according to claim 10, wherein a thickness A of the adhesive tape after soaking in the lithium-salt-free electrolyte at 85° C. for 24 h and a thickness B of the adhesive tape before soaking in the lithium-salt-free electrolyte satisfy: 0 μm≤A−B≤2 μm.

13. The adhesive tape according to claim 8, wherein after the adhesive tape is hot-pressed at a temperature of 85° C. under a pressure of 1 MPa for 1 h, a maximum single-side adhesive overflow width of the adhesive tape ranges from 0 mm to 1 mm.

14. The adhesive tape according to claim 8, wherein the binder further comprising a tackifying resin, an antioxidant, and an additive; wherein
the tackifying resin comprises at least one of rosin resin, terpene resin, C5 petroleum resin, C9 petroleum resin, or coumarone resin;
the antioxidant comprises at least one of pentaerythritol tetrakis(3,5-di-tert-butyl-4-hydroxy)phenylpropionate, n-octadecyl 3-(3,5-di-tert-butyl-4-hydroxyphenyl)propionate, tris(2,4-di-tert-butylphenyl) phosphite, bis(2,4-di-tert-butylphenyl)pentaerythritol diphosphite, distearyl thiodipropionate, bis(3,5-di-tert-butyl-4-hydroxyphenylpropionyl)hydrazine, 1,3,5-tris(3,5-di-tert-butyl-4-hydroxybenzyl)-1,3,5-triazine-2,4,6(1H,3H,5H)-trione, pentaerythritol tetrakis(3-laurylthiopropionate), or 4,6-bis(dodecylthiomethyl)-o-cresol;
the additive comprises at least one of carbon black, alumina, or titanium dioxide; and
based on a mass of the binder, a mass percentage of the tackifying resin ranges from 5% to 15%, a mass percentage of the antioxidant ranges from 2% to 5%, and a mass percentage of the additive ranges from 2% to 5%.

15. The adhesive tape according to claim 8, wherein a mass ratio of the acrylic resin to the styrene-isoprene-styrene block copolymer ranges from 1:1 to 2:1.

16. The adhesive tape according to claim 15, wherein the mass ratio of the acrylic resin to the styrene-isoprene-styrene block copolymer ranges from 1.2:1 to 1.8:1.

17. The adhesive tape according to claim 16, wherein the mass ratio of the acrylic resin to the styrene-isoprene-styrene block copolymer ranges from 1.4:1 to 1.6:1.

18. The adhesive tape according to claim 8, wherein a weight-average molecular weight of the polyethylene glycol ranges from 300 to 8500, a weight-average molecular weight of the styrene-isoprene-styrene block copolymer ranges from 80000 to 120000, and a weight-average molecular weight of the acrylic resin ranges from 100000 to 200000.

19. An electrochemical apparatus, comprising the adhesive tape according to claim 8.

20. An electric apparatus, comprising the electrochemical apparatus according to claim 19.
